(19) United States
(12) Patent Application Publication
(10) Pub. No.: US 2011/0304712 A1
(43) Pub. Date: Dec. 15, 2011

(54) STEREOSCOPIC DISPLAY SYSTEM, STEREOSCOPIC DISPLAY DEVICE AND GLASSES FOR STEREOSCOPIC VIDEO IMAGE OBSERVATION

(75) Inventors: Takahiro KOobayashi, Osaka (JP); Hiroshi Miyai, Hyogo (JP); Seiji Hamada, Osaka (JP); Yoshio Umeda, Hyogo (JP)

(73) Assignee: PANASONIC CORPORATION, Kadoma-shi, Osaka (JP)

(21) Appl. No.: 13/203,201

(22) PCT Filed: Nov. 8, 2010
(86) PCT No.: PCT/JP2010/006539

§ 371 Date: Aug. 24, 2011

(30) Foreign Application Priority Data
Dec. 7, 2009 (JP) 2009-277276

(51) Int. Cl. H04N 13/04

(52) U.S. Cl. 348/51; 348/E13.075

(57) ABSTRACT

Provided are a stereoscopic display device and stereoscopic display system, and a stereoscopic display device and glasses for stereoscopic video image observation, which are capable of reducing flicker attributable to the influence of a fluorescent lamp while preventing increase in crosstalk. Specifically, provided is a stereoscopic display system provided with: a stereoscopic display device which displays left-eye video images and right-eye video images alternatively in terms of time, the left-eye video images and right-eye video images being based on inputted left-eye video signals and right-eye video signals; and glasses for stereoscopic observation which comprise left-eye shutter and right-eye shutter configured to adjust quantities of light passing through the glasses toward the respective left and right eyes, and with which the left-eye video images and right-eye video images are observed. The stereoscopic display system is further provided with: an ambient light detecting unit which detects ambient light surrounding the system; and a shutter controlling unit which, so that changes in quantities of ambient light entering the respective left and right shutters can be reduced, controls quantities of light passing through the respective left and right shutters.

### TECHNICAL FIELD

The present invention relates to a stereoscopic display system to observe stereoscopic video using glasses for observing stereoscopic images, and a stereoscopic display apparatus to use in this system.

### BACKGROUND ART

As a conventional stereoscopic display apparatus to obtain stereoscopic video, a method of alternately supplying left-eye video and right-eye video having a parallax to a display in a predetermined cycle (for example, a field cycle) and observing images thereof through stereoscopic image observation glasses having a liquid crystal shutter driven in synchronization with a predetermined cycle has been known (see, for example, patent literature 1).

FIG. 1 shows a block diagram of a stereoscopic display system according to the related art, and a case where left and right video signals of 60 Hz are inputted will be described.

Stereoscopic video processing section 101 receives the left and right video signals of 60 Hz, converts the left and right video signals into signals in a period of 120 Hz, and outputs the left and right video signals of 120 Hz to display drive section 102. Display drive section 102 converts the left and right video signals of 120 Hz into a format displayable on display 103, and outputs the converted left and right video signals to display 103. Therefore, left and right images are alternately displayed on display 103 in a period of 120 Hz.

Meanwhile, left-side glass position control circuit 104L and right-side glass position control circuit 104R respectively control left glass shutter 105L and right glass shutter 10R of stereoscopic image observation glasses 105, on the basis of the synchronization with 120 Hz in stereoscopic video processing section 101. Glass position control circuits 104L and 104R control opening and closing of glass shutters 105L and 105R, such that open periods of the shutters become halves of the respective video periods to be in synchronization with the alternate left and right output images of display 103. The left and right images passing through glass shutters 105L and 105R are inputted to left and right eyes of a person, respectively, and as a result, visual stereoscopic images are generated in the brain of the person.

However, indoors, together with the video from the display, light from a fluorescent lamp is also incident to the stereoscopic image observation glasses shown in the example according to the related art. If the fluorescent lamp is blinking on and off in synchronization with the power supply frequency and the period of the blinking has a specific relation with a driving period of the stereoscopic image observation glasses, flicker may be caused.

This flicker will be described with reference to FIG. 2. FIG. 2 is a control timing chart of a stereoscopic display apparatus according to the related art. Now, a description will be made on the assumption that display 103 is a CRT display. In FIG. 2, FIG. 2A shows scan timings of left and right video signals in display 103, FIG. 2B shows opening and closing timings of glass shutters 105L and 105R, FIG. 2C shows a variation in the intensity of light of a fluorescent lamp in the vicinity of the device with time, and FIG. 2D shows the intensities of light of the fluorescent lamp passing through glass shutters 105L and 105R. A waveform of a light intensity of a fluorescent lamp in an area where a frequency of a commercial power supply is 50 Hz becomes a full-wave rectified waveform of 50 Hz. Therefore, the waveform is repeated in a period of 100 Hz. Therefore, the waveform is repeated in a period of 100 Hz. Integration is performed for a component of the waveform of the light intensity of the fluorescent lamp of 100 Hz and a component of the opening and closing timings of the glass shutters of 60 Hz (a duty ratio of opening and closing is 1:3 (25%) in FIG. 2), thereby obtaining waveforms of light passing through respective glass shutters 105L and 105R of FIG. 2D. As shown by the waveforms and numerical values written within the waveforms in FIG. 2D, for example, the integrated value of the light passing through the right shutter changes to 56%, 48%, 21%, and 56%, and has a period of 20 Hz. (Here, those numerical values are obtained by normalizing an integrated value of a half period (a half period of the period of 50 Hz) of the variation of light intensity of the fluorescent lamp in FIG. 9D and expressing the normalized value in percent.) The frequency component of the waveform with the period of 20 Hz is perceived as flicker by eyes, and thus becomes a disturbance.

By contrast with this, to improve the above flicker of 20 Hz, a method of avoiding flicker by providing a glass pulse width control circuit to change the opening/closing time of glasses is disclosed (see, for example; patent literature 2). As shown in FIG. 3, compared with the conventional example shown in FIG. 1, this method adds right-side glass pulse width control circuit 141R and left-side glass pulse width control circuit 141L. The duration of an open period in which glasses are in an open state (that is, in a state in which light transmits) is basically coordinated with the fluorescent lamp cycle period (10 msec) of 100 Hz, by left-side glass pulse width control circuit 141L and right-side glass pulse width control circuit 141R. On the other hand, the duration of a closed period in which glasses are in a closed state (that is, in a state in which light is blocked) is coordinated with the remaining time (6.7 msec) of the cycle period (16.7 msec) of the glasses of 60 Hz. Accordingly, the open period of glasses matches the cycle length of the luminous intensity waveform of a fluorescent lamp of 100 Hz, so that flicker does not occur.

### CITATION LIST

### Patent Literature

PTL 1
Japanese Patent Application Laid-Open No. 62-133891
PTL 2
Japanese Patent Application Laid-Open No. 9-138384

### SUMMARY OF PRESENT INVENTION

### Technical Problem

However, in the method of Patent Literature 2, there is the following problem. If the shutters of the glasses are set to the durations of the open and closed periods as described above, the open periods of the left and right shutters overlap each other. Therefore, the left-eye video are leaked into the right glass shutter and the right-eye video are leaked into the left glass shutter, which causes a problem called crosstalk in which disturbance images enter the left and right eyes. In Patent Literature 2, the period when the open periods overlap each other is adjusted to a blanking period when a valid video of a counter video (a left field image in a case of the right side and a right field image in a case of the left side) does not exist, thereby making the open periods close to 10 msec. In this way, disturbances of the crosstalk and the flicker are reduced in a well-balanced manner.

However, the method of reducing the flicker may not sufficiently achieve the effect of reducing the flicker by the length of the blanking period. Meanwhile, if the open periods of the shutters are set to be longer, there is a problem in which the disturbance of the crosstalk increases.

An object of the present invention is to provide a stereoscopic display system, and a stereoscopic display apparatus and stereoscopic image observation glasses, which can reduce flicker due to the influence of a fluorescent lamp while preventing crosstalk from increasing.

### Solution to Problem

In order to solve the problem, a stereoscopic display system according to the present invention includes a stereoscopic display apparatus that temporarily alternately displays left-eye video and right-eye video based on inputted left-eye video signals and right-eye video signals, and stereoscopic image observation glasses which have a left shutter for a left eye and a right shutter for a right eye for controlling light transmission amounts toward a left eye and a right eye and with which the left-eye video and the right-eye video are observed, and further includes an ambient light detecting section that detects ambient light of the stereoscopic display system, and a shutter control section that controls the amounts of transmitting light in the left shutter and the right shutter such that variation in amounts of ambient light that is incident on the left shutter and the right shutter, is reduced.

Further, a stereoscopic display apparatus according to the present invention is used for a stereoscopic display system including a stereoscopic display apparatus that temporarily alternately displays left-eye video and right-eye video based on inputted left-eye video signals and right-eye video signals, and stereoscopic image observation glasses which have a left shutter for a left eye and a right shutter for a right eye for controlling light transmission amounts toward a left eye and a right eye and with which the left-eye video and the right-eye video are observed, and includes an ambient light detecting section that detects ambient light of the stereoscopic display apparatus, and a shutter control section that controls the amounts of transmitting light in the left shutter and the right shutter such that variation in amounts of ambient light that is incident on the left shutter and the right shutter, is reduced.

Furthermore, stereoscopic image observation glasses according to the present invention is used for a stereoscopic display system including a stereoscopic display apparatus that temporarily alternately displays left-eye video and right-eye video based on inputted left-eye video signals and right-eye video signals, and stereoscopic image observation glasses which have a left shutter for a left eye and a right shutter for a right eye for controlling light transmission amounts toward a left eye and a right eye and with which the left-eye video and the right-eye video are observed, and includes an ambient light detecting section that detects ambient light of the stereoscopic image observation glasses, and a shutter control section that controls the amounts of transmitting light in the left shutter and the right shutter such that variation in amounts of ambient light that is incident on the left shutter and the right shutter, is reduced.

### Advantageous Effects of Invention

According to the stereoscopic display apparatus and the stereoscopic display system of the present invention, it is possible to provide a stereoscopic display system, and a stereoscopic display apparatus and stereoscopic image observation glasses, which can reduce flicker due to the influence of a fluorescent lamp while preventing crosstalk from increasing.

### BRIEF DESCRIPTION OF DRAWINGS

FIG. 1 is a block diagram of a stereoscopic display system according to the related art;

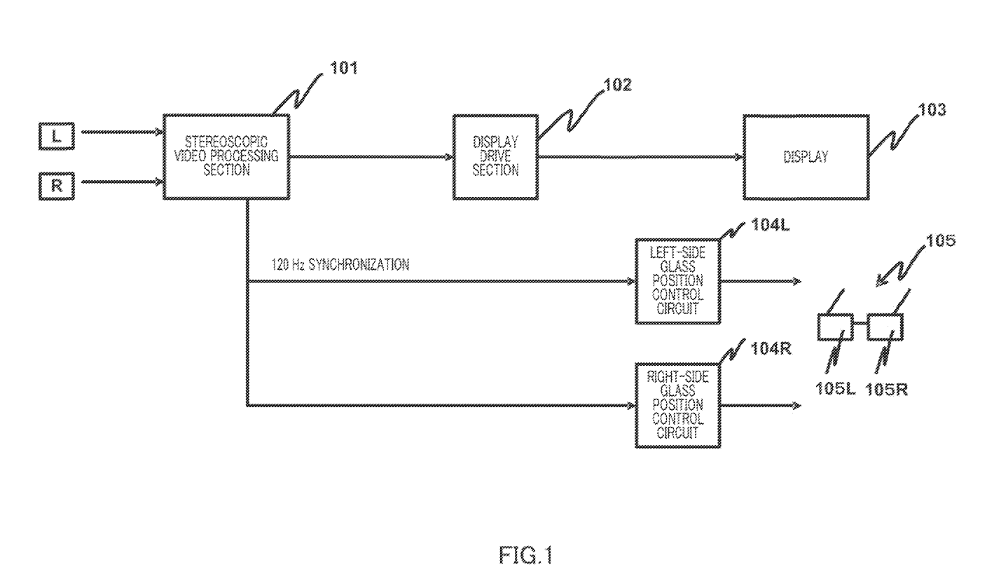

FIG. 2 is a control timing chart of a stereoscopic display apparatus according to the related art, wherein FIG. 2A shows scan timings of left and right video signals, FIG. 2B shows opening and closing timings of glass shutters, FIG. 2C shows the intensity of light of a fluorescent lamp in the vicinity of the stereoscopic display apparatus, and FIG. 2D shows the intensities of light passing through the shutters;

FIG. 3 is a block diagram of a stereoscopic display system for reducing flicker according to the related art;

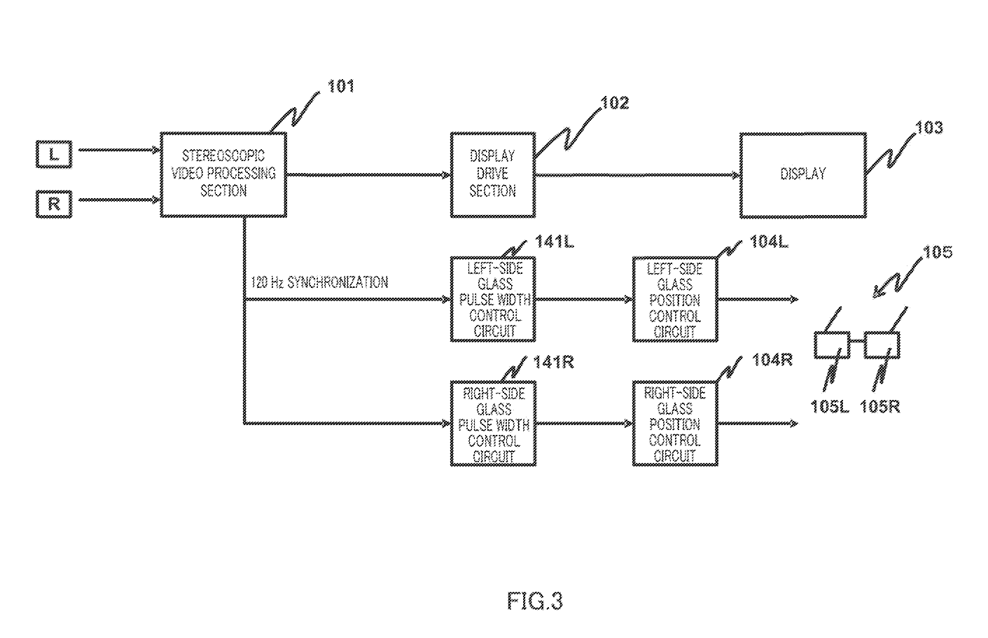

FIG. 4 is a block diagram illustrating a configuration of a stereoscopic display system according to Embodiment 1;

FIG. 5 is a control timing chart of the stereoscopic display system according to Embodiment 1, wherein FIG. 5A is a view illustrating scan timings of left and right video signals, FIG. 5B is a view illustrating timings for performing control such that light emission of a backlight is turned on and off, and a light emission period of the backlight, FIG. 5C is a view illustrating opening and closing timings and light transmittances of shutters, FIG. 5D is a view illustrating the light intensity of a fluorescent lamp in the vicinity of the stereoscopic display apparatus, FIG. 5E is a view illustrating the intensities of light passing through the shutters, FIG. 5F is a view illustrating a driven screen brightness, and FIG. 5G is a view illustrating the screen brightness after passing through the shutters;

FIG. 6 is a block diagram illustrating a configuration of a modification of Embodiment 1;

FIG. 7 is a control timing chart of a stereoscopic display system according to Embodiment 2, wherein FIG. 7A is a view illustrating scan timings of left and right video signals, FIG. 7B is a view illustrating timings for performing control such that light emission of a backlight is turned on and off, and a light emission period of the backlight, FIG. 7C is a view illustrating opening and closing timings and light transmittances of shutters, FIG. 7D is a view illustrating the light intensity of a fluorescent lamp in the vicinity of the stereoscopic display apparatus, FIG. 7E is a view illustrating the intensities of light passing through the shutters, FIG. 7F is a view illustrating a driven screen brightness, and FIG. 7G is a view illustrating the screen brightness after passing through the shutters:

FIG. 8 is a block diagram illustrating a stereoscopic display system according to Embodiment 3;

FIG. 9 is a control timing chart of the stereoscopic display system according to Embodiment 3, wherein FIG. 9A is a view illustrating scan timings of left and right video signals, FIG. 9B is a view illustrating timings for performing control such that light emission of a backlight is turned on and off, and a light emission period of the backlight, FIG. 9C is a view illustrating opening and closing timings and light transmittances of shutters, FIG. 9D is a view illustrating the light intensity of a fluorescent lamp in the vicinity of the stereoscopic display apparatus, FIG. 9E is a view illustrating the intensities of light passing through the shutters, FIG. 9F is a view illustrating a driven screen brightness, and FIG. 9G is a view illustrating the screen brightness after passing through the shutters; and

FIG. 10 is a block diagram illustrating a configuration of a modification of Embodiment 3.

### DESCRIPTION OF EMBODIMENTS

Hereinafter, embodiments of the present invention will be described with reference to the drawings. Throughout the following Embodiments, identical components are denoted by the same reference symbols, and the redundant description thereof may not be repeated here.

### Embodiment 1

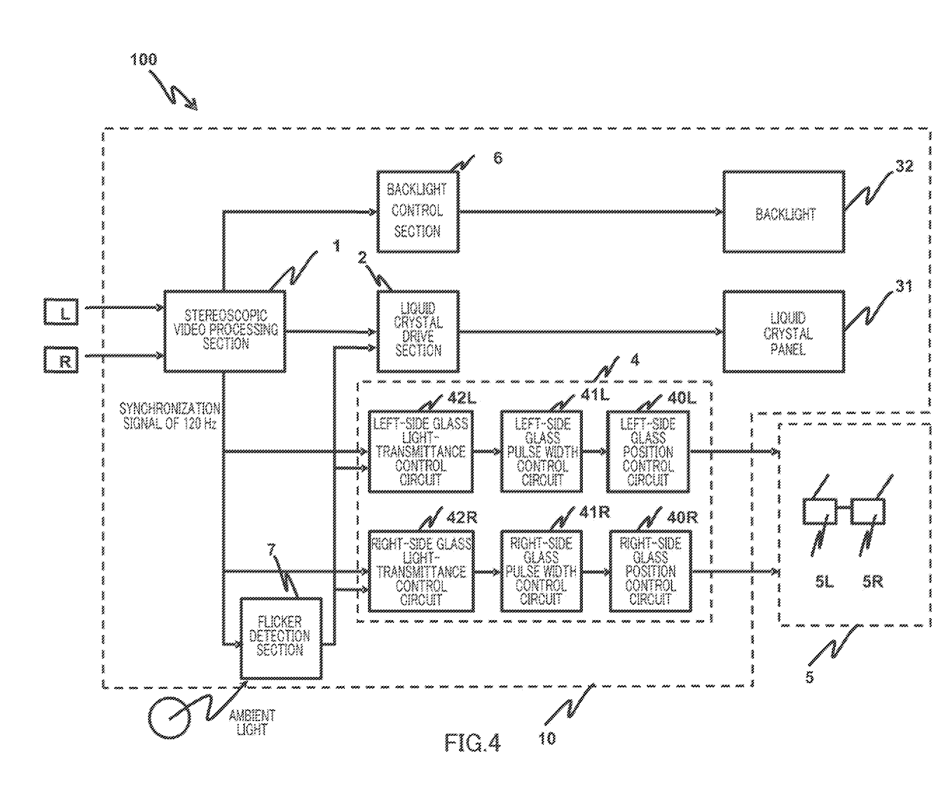

FIG. 4 is a block diagram illustrating a configuration of a stereoscopic display system according to Embodiment 1. Stereoscopic display system 100 includes stereoscopic display apparatus 10, and stereoscopic image observation glasses having left and right shutters 5L and 5R whose open and closed states are controlled in accordance with left-eye video and right-eye video by stereoscopic display apparatus 10.

Stereoscopic display apparatus 10 includes stereoscopic video processing section 1, liquid crystal drive section 2, liquid crystal panel 31, backlight 32, shutter control section 4, backlight control section 6, and flicker detection section 7.

Stereoscopic video processing section 1 receives left and right video signals (left-eye video signals and right-eye video signals) having a fundamental vertical synchronization frequency. Then, stereoscopic video processing section 1 divides the inputted left-eye and right-eye video signals into left-eye video signals and right-eye video signals at a frequency which is N times (N is a positive integer of 1 or more) the fundamental vertical synchronization frequency, and outputs the left-eye video signals and the right-eye video signals. In Embodiment 1, the inputted left and right video signals of 60 Hz are converted into signals of a period of 120 Hz, and the signals of 120 Hz are output to liquid crystal drive section 2, shutter control section 4, backlight control section 6, and flicker detection section 7. Stereoscopic video processing section 1 may not output all of the left and right video signals if necessary. For example, only the synchronization signal of 120 Hz may be outputted to shutter control section 4 and flicker detection section 7.

Liquid crystal drive section 2 converts the left and right video signals of 120 Hz into a format displayable on liquid crystal panel 31. Liquid crystal drive section 2 outputs the converted left and right video signals to liquid crystal panel 31.

Liquid crystal panel 31 modulates incident light from a rear surface in accordance with the inputted left-eye video signals and right-eye video signals, and sequentially displays left-eye video and right-eye video. Liquid crystal panel 31 may be various driving types such as an in-plane switching (IPS) type, a vertical alignment (VA) type, a twisted nematic (TN) type, and the like.

Backlight 32 illuminates liquid crystal panel 31 with light from the rear surface. Backlight 32 may be a backlight which emits planar light by using a plurality of light emitting diodes arranged two-dimensionally. Also, backlight 32 may be a backlight that can emit planar light by arranging a plurality of fluorescent tubes in parallel. Further, backlight 32 may be an edge type backlight in which light emitting diodes or a fluorescent tube is disposed in an edge portion. Backlight 32 emits light in accordance with a light emission control signal which is outputted from backlight control section 6 on the basis of the synchronization signal of 120 Hz outputted from stereoscopic video processing section 1.

Shutter control section 4 controls the open and closed states of the left and right shutters of glasses 5 for stereoscopic video observation with open and closed periods according to the display period of the left-eye video and the right-eye video. In Embodiment 1, since shutter control section 4 controls the open and closed states in accordance with the display period, 120 Hz, of the left-eye video and the right-eye video, the open and closed periods of each of the left and right shutters are controlled at 60 Hz. Shutter control section 4 includes left-side glass position control circuit 40L, right-side glass position control circuit 40R, left-side glass pulse width control circuit 41L, right-side glass pulse width control circuit 41R, left-side glass light-transmittance control circuit 42L, and right-side glass light-transmittance control circuit 42R.

Flicker detection section 7 is an ambient light detecting section that detects ambient light of stereoscopic display system 100. In Embodiment 1, flicker detection section 7 detects ambient light of stereoscopic display apparatus 10. Then, flicker detection section 7 detects a variation of brightness of the ambient light from the detected ambient light of stereoscopic display apparatus 10, and detects existence or nonexistence of flicker attributable to interference of the period of the variation in brightness and the open and closed periods of the shutters. For example, flicker detection section 7 may determine existence of flicker in a case where the amplitude of flicker is a predetermined value or greater, and determine nonexistence of flicker in a case where the amplitude of flicker is the predetermined value or less. In Embodiment 1, flicker detection section 7 receives the synchronization signal having a period of 120 Hz of the left and right video signals and ambient light from a fluorescent lamp, and detects flicker of the fluorescent lamp in an area where the power supply frequency is 50 Hz.

Left and right-side glass light-transmittance control circuits 42L and 42R determine the light transmittances of the shutters on the basis of the variation of brightness of the ambient light detected by flicker detection section 7 and the synchronization signal of 120 Hz of stereoscopic video processing section 1. Left and right-side glass pulse width control circuits 41L and 41R receive output signals of left and right-side glass light-transmittance control circuits 42L and 42R, and determine the pulse durations of the open periods of left and right shutters 5L and 5R, respectively. Left and right-side glass position control circuits 40L and 40R receive output signals of left and right-side glass pulse width control circuits 41L and 41R, and determine the phases of the open periods of the shutters. Then, the open and closed states of left and right shutters 5L and 5R are controlled by output signals of left and right-side glass position control circuits 40L and 40R.

Shutter control section 4 sets the pulse durations of the open periods (the durations of the open periods) of shutters 5L and 5R and the opening and closing positions of the shutters (phases of the open periods of the shutters), in consideration of the response characteristic of liquid crystal panel 31, and crosstalk between the left-eye video and the right-eye video. In Embodiment 1, the pulse widths of shutters 5L and 5R are set to 25% of one period (16.7 msec) of the left and right video signals of 60 Hz (the duty ratio is 25%), and the opening positions of shutters 5L and 5R are set to positions of halves of left and right video signal scan periods, respectively. These pulse widths and the opening and closing positions of the shutters are controlled by left and right-side glass pulse width control circuits 41L and 41R and left and right-side glass position control circuits 40L and 40R.

In a case where flicker detection section 7 detects flicker, in order to prevent flicker from occurring in a fluorescent lamp in an area where the frequency of the commercial power supply is 50 Hz, left and right-side glass light-transmittance control circuits 42L and 42R change the light transmittances of shutters 5L and 5R according to the variation of brightness of the fluorescent lamp which is the detected ambient light. In other words, shutter control section 4 controls light transmission amounts such that a variation in an amount of passing light of ambient light in the open periods that are temporarily consecutive is reduced in each of shutters 5L and 5R. Specifically, shutter control section 4 controls the light transmittances of shutters 5L and 5R such that the light transmittances decrease in a period in which the amount of passing light of ambient light is larger.

Liquid crystal drive section 2 changes a screen brightness to compensate for the variation of light transmittance caused by the left and right-side glass light-transmittance control circuits 42L and 42R. Specifically, liquid crystal drive section 2 gives gains to the left and right video signals to be output to liquid crystal panel 31, in accordance with the light transmittances of shutters 5L and 5R, so as to control the transmittance of liquid crystal panel 31, thereby controlling screen brightness. Liquid crystal drive section 2 controls liquid crystal panel 31 such that the screen brightness becomes high in an open period when the light transmittances are lowers.

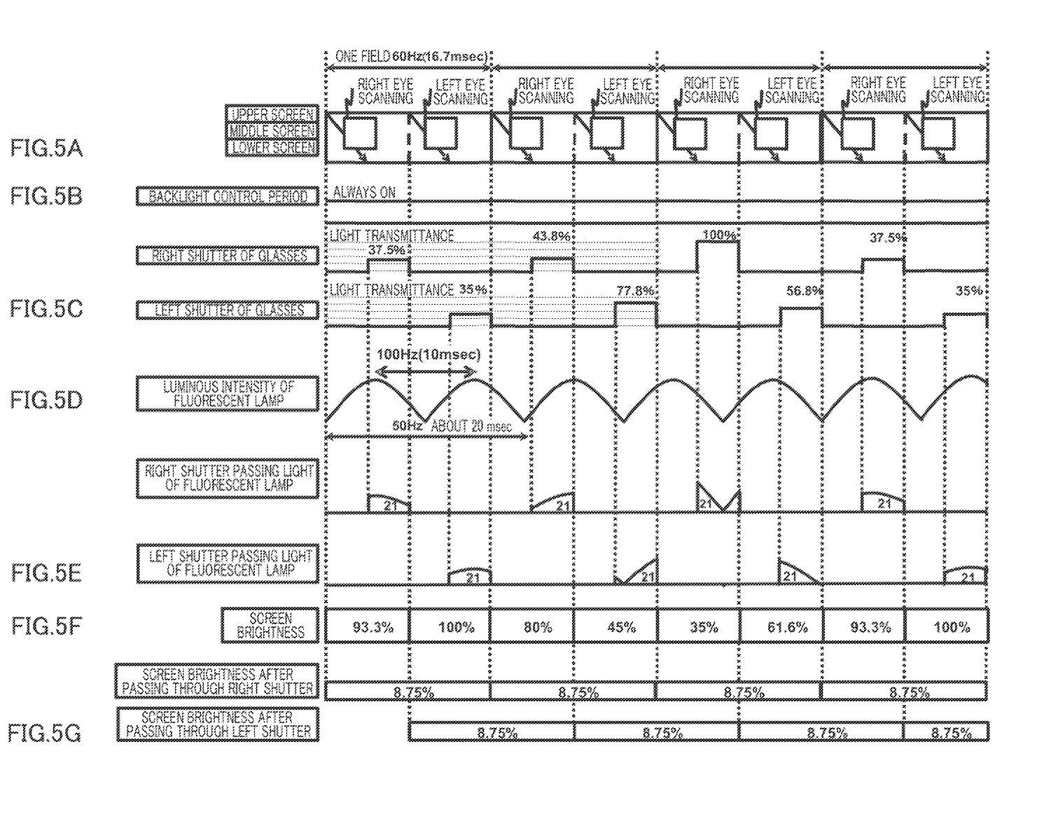

FIG. 5 is a control timing chart of the stereoscopic display system 100. In FIG. 5, FIG. 5A shows scan timings of left and right video signals in liquid crystal panel 31, FIG. 5B shows timings for performing control such that light emission of backlight 32 is turned on and off by backlight control section 6, and a light emission period of the backlight 32, FIG. 5C shows the opening and closing timings and light transmittances of shutters 5L and 5R, FIG. 5D shows the light intensity of the fluorescent lamp in the vicinity of the stereoscopic display apparatus, FIG. 5E shows the intensities of light of the fluorescent lamp passing through shutters 5L and 5R, FIG. 5F shows the screen brightness of liquid crystal panel 31 driven by liquid crystal drive section 2, and FIG. 5G shows the screen brightness of liquid crystal panel 31 after passing through shutters 5L and 5R. Here, since the power supply frequency is 50 Hz, the peak frequency of the waveform of the light intensity of the fluorescent lamp becomes 100 Hz (10 msec), as shown in FIG. 5D. Here, left and right-side glass light-transmittance control circuits 42L and 42R determine and control the light transmittances of the open periods of shutters 5L and 5R on the basis of the phase relation between the waveform of the detected light intensity of the fluorescent lamp and the synchronization signal of 120 Hz of the left and right video, such that the intensity of the light of the fluorescent lamp after passing through the shutters becomes constant in consecutive open periods. Numerical values shown in FIG. 5C represent light transmittance. Therefore, it is possible to make the intensity of the light of the fluorescent lamp passing through the shutters constant as shown in FIG. 5E, so that flicker does not occur.

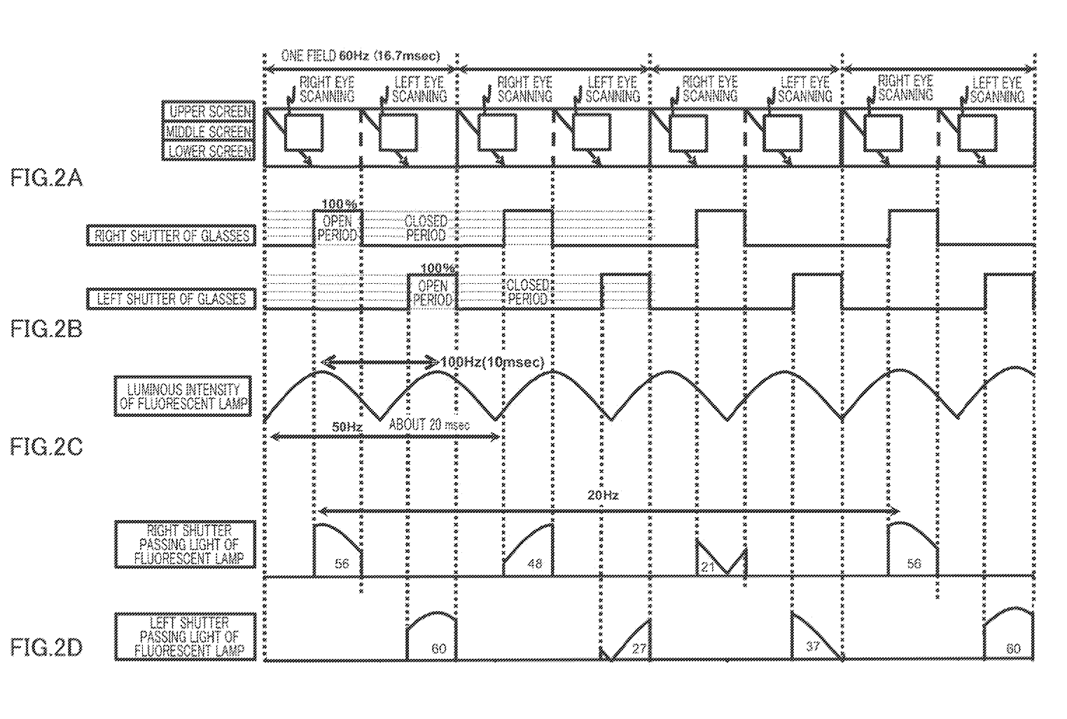

This point will be described by using numerical examples. In a case where the light transmittances of the left and right shutters are not controlled, the amounts of light, passing through the shutters, of light of the fluorescent lamp which is ambient light, are as shown in FIG. 2D, for example. In other words, in the right shutter, the light transmission amount in the opening periods of the shutter changes to 56%, 48%, 21%, and 56%, and has a period of 20 Hz. Further, in the left shutter, the light transmission amount in the opening periods of the shutter changes to 60%, 27%, 30%, and 60%, and has a period of 20 Hz. Here, shutter control section 4 controls left and right shutters 5L and 5R such that the variation in the amounts of transmitting light is reduced in accordance with a period variation of flicker. In other words, shutter control section 4 controls the light transmittances of the shutters on the basis of 21% of the right shutter which is the lowest value for the amount of transmitting light, such that the light transmission amounts in the other open periods of the shutters become 21%. Specifically, as shown in FIG. 5C, shutter control section 4 controls the light transmittance of the right shutter to be 37.5%, 43.8%, 100%, and 37.5%. Also, shutter control section 4 controls the light transmittance of the left shutter to be 35%, 77.8%, 56.8%, and 35%. This control makes it possible to the transmission amounts of the light of the fluorescent lamp, which is ambient light, constant at 21% in all of the open periods of the shutters as shown in FIG. 5E. That is, it is possible to reduce the flicker.

Simultaneously with this, liquid crystal drive section 2 controls the screen brightness of liquid crystal panel 31, such that the screen brightness of the left and right video based on the variation of light transmittance in shutters 5L and 5R in the open periods becomes constant after passing through the shutters, as shown in FIG. 5F. Since the screen brightness after passing through the shutters becomes constant, a variation in the brightness of stereoscopic video does not occur.

This point will be described with reference to numerical examples. In a case where liquid crystal drive section 2 does not control the screen brightness of liquid crystal panel 31 in a state in which the light transmittances of the shutters are controlled as described above (a case where the screen brightness of FIG. 5F is always 100%), the screen brightness after passing through the left and right shutters varies according to the light transmittances of the shutters. Here, on the basis of 35% of the left shutter which is the lowest value of the light transmittances of the shutters, liquid crystal drive section 2 controls the screen brightness of the left and right images corresponding to the other open periods of the shutters. Specifically, as shown in FIG. 5F, liquid crystal drive section 2 controls the screen brightness of the right video such that the screen brightness becomes 93.3%, 80%, 35%, and 93.3%. Also, liquid crystal drive section 2 controls the screen brightness of the left video such that the screen brightness becomes 100%, 45%, 61.6%, and 100%. Since the duty ratios of the open periods of the left and right shutters are 25% as described above, on average for one field, it is possible to make the screen brightness of the left and right images finally passing though the left and right shutters constant at 8.75% as shown in FIG. 5G. That is, it is possible to reduce the variation of screen brightness according to the control of the light transmittances of the shutters. Here, a percentage expressing the screen brightness of liquid crystal drive section 2 is a relative numerical value on the assumption that the screen brightness in the case where control according to the light transmittances of the shutters is not performed is set to 100%, and does not express the absolute value of the screen brightness.

In a case where no flicker is detected by flicker detection section 7 (for example, a case of an area where the frequency of the commercial power supply is 60 Hz), the light transmittances of shutters 5L and 5R are set to be constant at 100% without changing, and thus liquid crystal drive section 2 does not perform an operation to change the screen brightness according to the light transmittances. Therefore, there is no flicker. In this case, it is possible to increase the brightness of stereoscopic video passing through the shutter glasses.

In Embodiment 1, since the open periods of the right-eye shutter and the open periods of the left-eye shutter do not overlap each other, it is possible to suppress occurrence of crosstalk between left and right images.

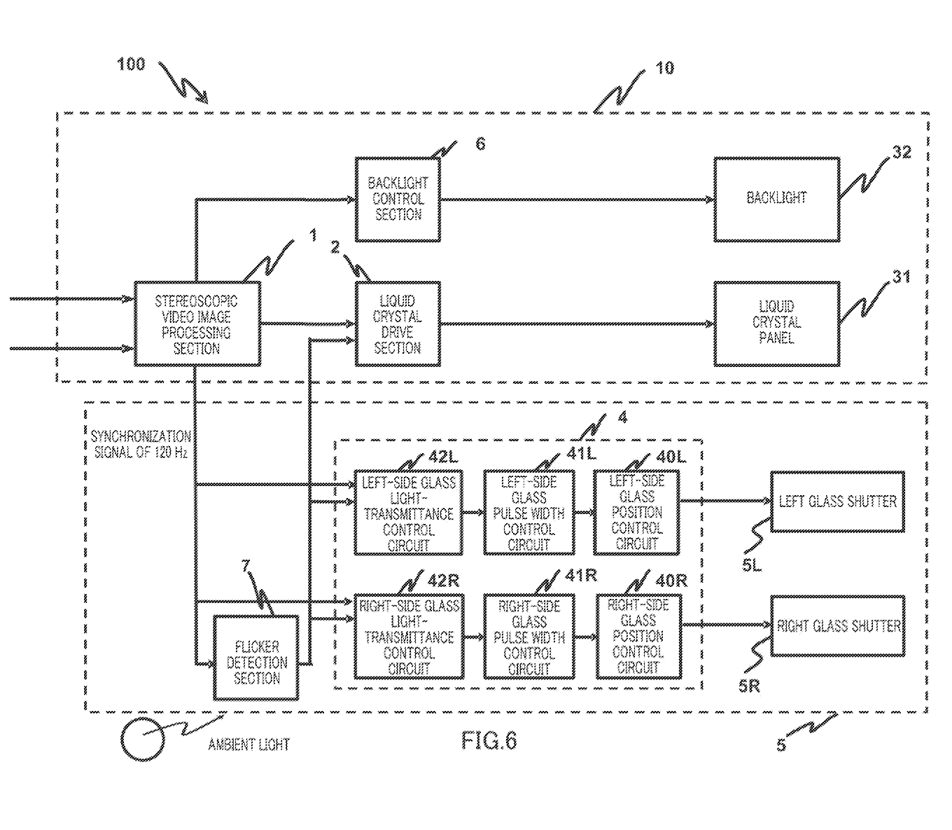

In Embodiment 1, shutter control section 4, flicker detection section 7, and liquid crystal drive section 2 are included in stereoscopic display apparatus 10; however, the present invention is not limited thereto. For example, as shown in FIG. 6, some components may be provided in glasses 5 for stereoscopic video observation. Naturally, all of shutter control section 4, flicker detection section 7, and liquid crystal drive section 2 may be provided in glasses 5 for stereoscopic video observation.

### Embodiment 2

Next, Embodiment 2 of the present invention will be described. A stereoscopic display system according to Embodiment 2 has the same configuration as that of Embodiment 1 shown in FIG. 4 except for the operation of shutter control section 4.

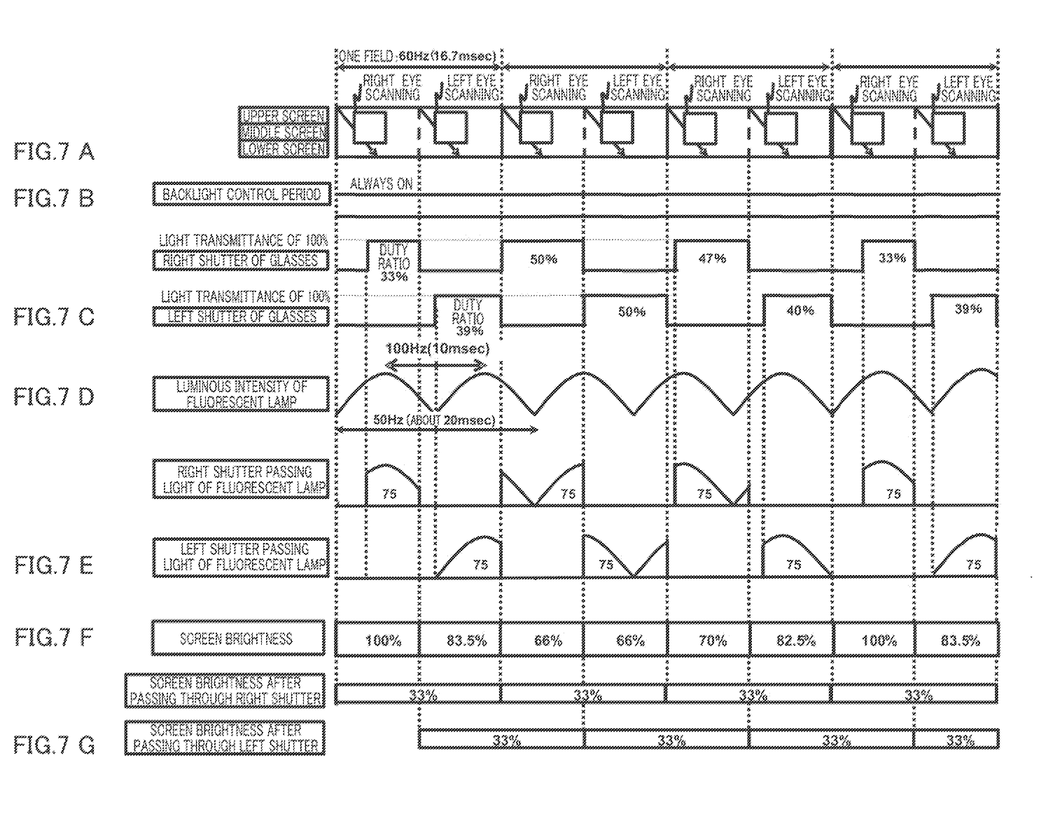

FIG. 7 shows a timing chart of the stereoscopic display system according to Embodiment 2. Only portions of FIG. 7 different from FIG. 5 will be described. FIG. 7C shows the opening and closing timings and light transmittances of shutters 5L and 5R. However, in FIG. 7C, the pulse widths of the shutters vary for each period (16.7 msec) of the left and right video signals of 60 Hz (the duty ratios vary), and the closing positions of the left and right shutters are set to the finish positions of left and right video scan periods, unlike the case shown in FIG. 5C. The pulse widths and the opening and closing positions of the shutters are controlled by left and right-side glass pulse width control circuits 41L and 41R and left and right-side glass position control circuits 40L and 40R. The light transmittances of the shutters are controlled by left and right-side glass light-transmittance control circuits 42L and 42R, such that the light transmittances are always 100%.

Here, as for the open periods of the shutters, the pulse widths of shutters 5L and 5R are determined from the phase relation between the waveform of the intensity of the light of the fluorescent lamp, which is the detected ambient light, and the synchronization signal of 120 Hz of the light and right video, such that the intensity of the light of the fluorescent lamp after passing through the shutter is constant in consecutive opening periods, whereby the opening positions of the shutters are controlled. Numerical values shown in FIG. 7C are obtained by expressing the pulse width as duty ratios (a ratio with respect to 16.7 ms which is one period of the left and right video signals). Therefore, it is possible to make the intensity of the light of the fluorescent lamp passing through each of the left and right shutters constant as shown in FIG. 7E, such that there is no flicker.

This point will be described with reference to numerical examples. In a case where the durations of the open periods of the left and right shutters are not controlled (a case where the duty ratios of the open periods are constant at 25%), the light transmission amounts in the open periods of the shutters, of the light of the fluorescent lamp, which is ambient light, become as shown in FIG. 2D, for example. In other words, in the right shutter, the light transmission amount in the opening periods of the shutter changes to 56%, 48%, 21%, and 56%, and has a period of 20 Hz. Further, in the left shutter, the light transmission amount in the opening periods of the shutter changes to 60%, 27%, 30%, and 60%, and has a period of 20 Hz. Here, shutter control section 4 controls left and right shutters 5L and 5R such that the variation in the amount of transmitting light is reduced in accordance with the variation period of flicker. In other words, shutter control section 4 controls the durations of the open periods of the left and right shutters such that the light transmission amounts in the open periods become constant. Specifically, as shown in FIG. 7C, shutter control section 4 controls the durations of the open periods of the right shutter such that the durations become 33%, 50%, 47%, and 33%. Also, shutter control section 4 controls the durations of the open periods of the left shutter such that the durations become 39%, 50%, 40%, and 39%. In Embodiment 2, shutter control section 4 controls off timings of the open periods of the shutters such that the off timings are fixed. In Embodiment 2, control is performed such that the maximum value of the durations of the open periods of the shutters is 50% and the light transmission amounts become the maximum. It is possible to use any other combinations of the durations of the opening periods of the left and right shutters making the light transmission amounts of the ambient light in the open periods of the shutters. This control makes it possible to make the light transmission amounts of the light of the fluorescent lamp, which is ambient light, constant at 75% in all the open periods of the shutters, as shown in FIG. 7E. That is, it is possible to reduce the flicker.

Simultaneously with this, liquid crystal drive section 2 controls the screen brightness of liquid crystal panel 31, as shown in FIG. 7F, such that the screen brightness of the left and right images based on the variations of the open periods (duty ratios) of shutters 5L and 5R become constant after passing through the shutters. Since the screen brightness after passing through the shutters become constant as shown in FIG. 7G, a variation in the brightness of stereoscopic video does not occur.

This point will be described with reference to numerical examples. In a case where liquid crystal drive section 2 does not control the screen brightness of liquid crystal panel 31 in a state in which the durations of the open periods of the shutters are controlled as described above (a case where the screen brightness of FIG. 7F is always 100%), the screen brightness after passing through left and right shutters varies according to the durations of the open periods of the shutters. Here, on the basis of the duration of the open period of the right shutter that is 33% which is the lowest value of the durations of the open periods of the shutters, liquid crystal drive section 2 controls the screen brightness of the left and right images corresponding to the other open periods of the shutters. Specifically, as shown in FIG. 7F, liquid crystal drive section 2 controls the screen brightness of the right images such that the screen brightness becomes 100%, 66%, 70%, and 100%. Also, liquid crystal drive section 2 controls the screen brightness of the left images such that the screen brightness becomes 83.5%, 66%, 82.5%, and 83.5%. As a result, it is possible to make the screen brightness of the left and right images passing though the left and right shutters constant at 33% as shown in FIG. 7G. That is, it is possible to reduce the variation of screen brightness according to the control of the light transmittances of the shutters. Here, a percentage expressing the screen brightness of liquid crystal drive section 2 is a relative numerical value on the assumption that the screen brightness in the case where control according to the durations of the open periods of the shutters is not performed is set to 100%, and does not express the absolute value of the screen brightness.

In Embodiment 2, since the open periods of the right-eye shutter and the open periods of the left-eye shutter do not overlap each other, it is possible to suppress occurrence of crosstalk between left and right images.

Also, in Embodiment 2, the open periods of the shutters in the case where the flicker is detected are set to be wider (it is possible to increase the duty ratios), as compared to Embodiment 1. Therefore, there is an effect that it is possible to increase the brightness of stereoscopic video passing through the shutter glasses.

In Embodiments 1 and 2, the backlight is always on. However, the backlight may be on only in the open periods of the left and right glass shutters. In this way, it is possible to suppress consumed power.

Similarly to Embodiment 1, in Embodiment 2, shutter control section 4, flicker detection section 7, and liquid crystal drive section 2 are included in stereoscopic display apparatus 10; however, the present invention is not limited thereto. For example, as shown in FIG. 6, some components may be provided in glasses 5 for stereoscopic video observation. Naturally, all of shutter control section 4, flicker detection section 7, and liquid crystal drive section 2 may be provided in glasses 5 for stereoscopic video observation.

In Embodiments 1 and 2, liquid crystal drive section 2 is an example of a video brightness control section that controls the brightness of the left-eye video and the right-eye video, which the stereoscopic display apparatus displays, according to the amounts of transmitting light in the left and right shutters.

In Embodiment 2, shutter control section 4 has a configuration that controls the light transmission amounts of the shutters by controlling the open periods (duty ratios) of the shutters. However, Embodiment 2 may be combined with Embodiment 1 to control all of the light transmittances and the durations of the open periods of the shutters, thereby controlling the light transmission amounts.

### Embodiment 3

Next, Embodiment 3 of the present invention will be described. Embodiment 3 is different from Embodiment 1 in the operation of the backlight control section.

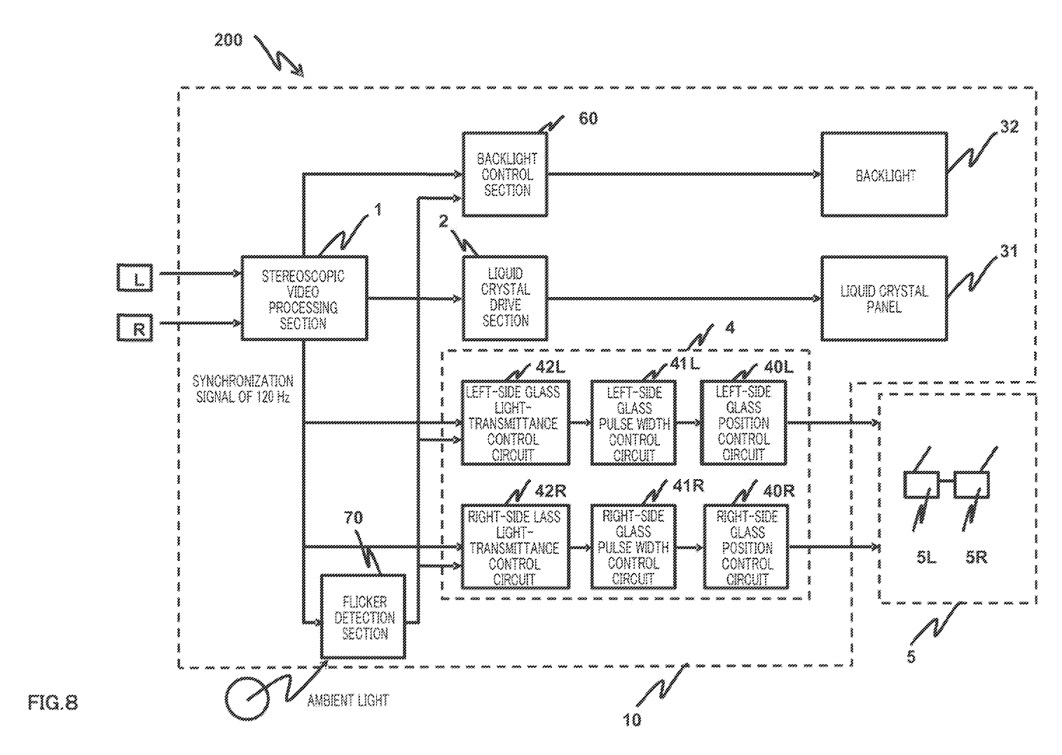

FIG. 8 shows a configuration of a stereoscopic display system according to Embodiment 3. A stereoscopic display system 200 includes backlight control section 60, instead of backlight control section 6 of Embodiment 1. Also, stereoscopic display system 200 includes flicker detection section 70, instead of flicker detection section 7 of Embodiment 1. The operation of flicker detection section 70 is basically the same as flicker detection section 7 of Embodiment 1, except that an output destination of a detection result is backlight control section 60.

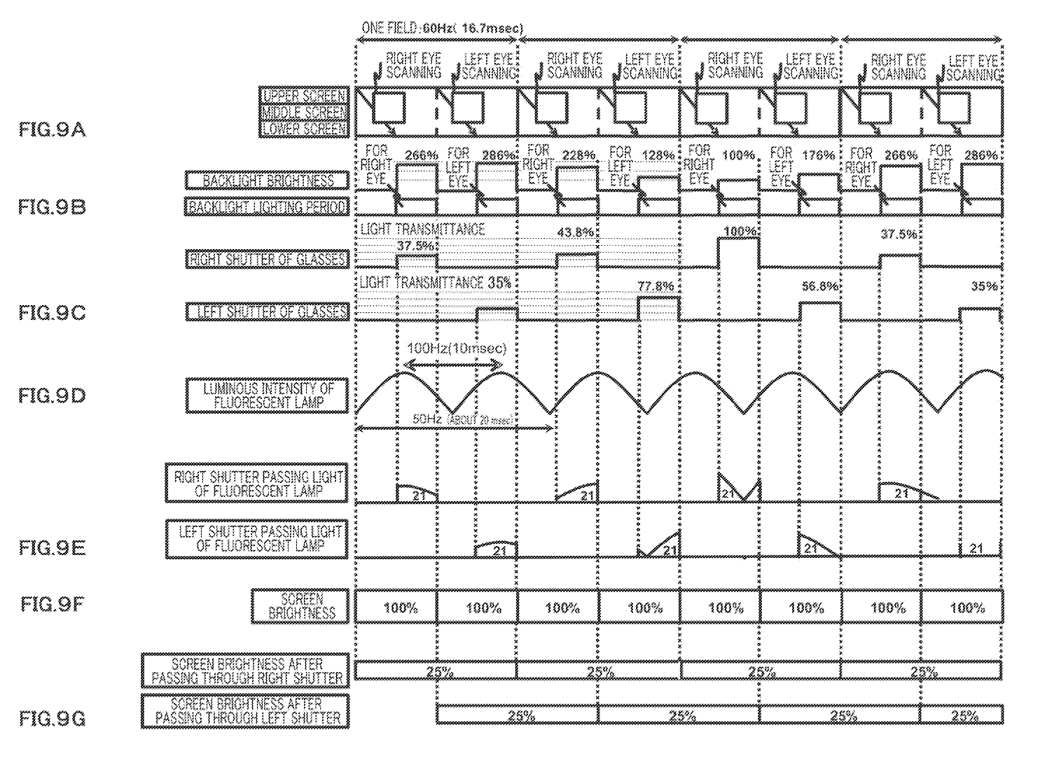

FIG. 9 shows a timing chart of stereoscopic display system 200 according to Embodiment 3. With regard to FIG. 9, only portions 9 different from FIG. 5 will be described. FIG. 5D shows the brightness and lighting timings of the backlight that is lighted in synchronization with the signal of 120 Hz synchronized with the left and right video signals. Backlight 32 is lightened for the left eye and the right eye in synchronization with the opening and closing timings of shutters 5L and 5R by backlight control section 60. As described with respect to Embodiment 1, in the case where the flicker of the fluorescent lamp is detected, the light transmittances of shutters 5L and 5R are controlled as shown in FIG. 9C. As a result, the intensity of the light of the fluorescent lamp passing through the shutters becomes constant, so that flicker does not occur as shown in FIG. 9E.

At this time, backlight control section 60 controls the lighting brightness of backlight 32 as shown by the backlight brightness (numerical values represent ratios with respect to a standard brightness) of FIG. 9B, such that a variation in the screen brightness of the left and right images caused by the variation of light transmittance in the open periods of shutters 5L and 5R becomes constant after passing through the shutters. That is, backlight control section 60 controls backlight 32 such that the lighting brightness becomes higher in an open period of the shutter with a lower light transmittance. Therefore, in Embodiment 3, the screen brightness after passing through the shutters becomes constant as shown in FIG. 9G, such that a variation in the brightness of stereoscopic video does not occur.

This point will be described with reference to numerical examples. In a case where backlight control section 60 does not control the lighting brightness of backlight 32 in a state that the light transmittances of the shutters are controlled as described above (a case where the backlight brightness of FIG. 9B is always 100%), the screen brightness after passing through left and right shutters varies according to the light transmittances of the shutters. Here, on the basis of 100% of the right shutter which is the highest value of the light transmittances of the shutters, backlight control section 60 controls the lighting brightness of the backlight corresponding to the other open periods of the shutters. Specifically, as shown in FIG. 9B, backlight control section 60 controls the lighting brightness of the backlight corresponding to the right video such that the lighting brightness becomes 266%, 228%, 100%, and 266%. Also, backlight control section 60 controls the lighting brightness of the backlight corresponding to the left video such that the lighting brightness becomes 286%, 128%, 176%, and 286%. Since the duty ratios of the open periods of the left and right shutters are 25% as described above, on average for one field, it is possible to make the screen brightness of the left and right images finally passing though the left and right shutters constant at 25% as shown in FIG. 9G. That is, it is possible to reduce the variation of screen brightness according to the control of the light transmittances of the shutters. Here, a percentage expressing the lighting brightness of backlight control section 60 is a relative numerical value on the assumption that the lighting brightness in the case where control according to the light transmittances of the shutters is not performed is set to 100%, and does not express the absolute value of the lighting brightness of the backlight.

In a case where no flicker is detected by flicker detection section 70 (for example, a case of an area where the frequency of the commercial power supply is 60 Hz), the light transmittances of shutters 5L and 5R may be set to be constant at 100% without changing, and backlight 32 may be always on by backlight control section 60. Therefore, there is no flicker. In this case, lowering of the temperature of liquid crystal panel 31 can be prevented by heat caused by lighting backlight 32. Therefore, it is possible to reduce a decrease in the liquid crystal response speed and reduce the crosstalk between the left and right images.

In Embodiment 3, similarly to the other Embodiments, since the open periods of the right-eye shutter and the open periods of the left-eye shutter do not overlap each other, it is possible to suppress occurrence of crosstalk between left and right images. Further, in Embodiment 3, in a case where the flicker is detected, the lighting brightness of the backlight can be set to be high, as compared to Embodiment 1. Therefore, there is an effect that it is possible to increase the brightness of stereoscopic video passing through the shutter glasses.

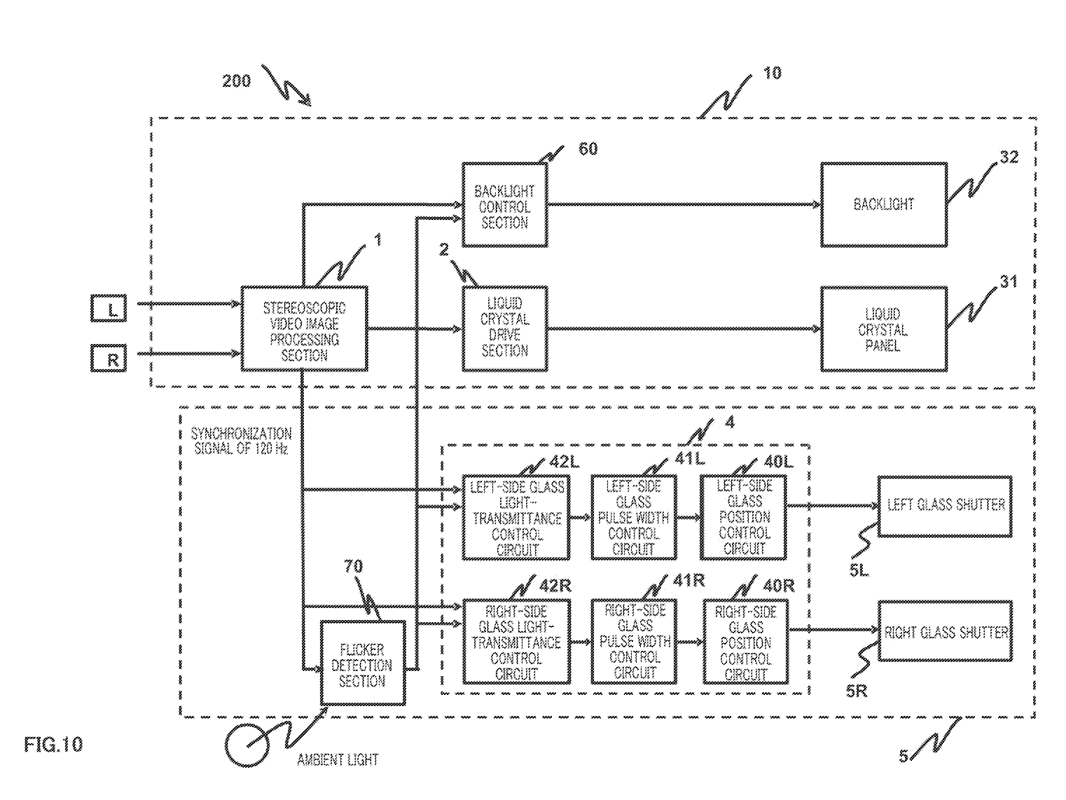

In Embodiment 3, shutter control section 4, flicker detection section 70, and backlight control section 60 are included in stereoscopic display apparatus 10; however, the present invention is not limited thereto. For example, as shown in FIG. 10, some components may be provided in glasses 5 for stereoscopic video observation. Naturally, all of shutter control section 4, flicker detection section 70, and backlight control section 60 may be provided in glasses 5 for stereoscopic video observation.

In Embodiment 3, backlight control section 60 is an example of a video brightness control section that controls the brightness of the left-eye video and the right-eye video, which the stereoscopic display apparatus displays, according to the amounts of transmitting light in the left and right shutters.

In Embodiment 3, similarly to Embodiment 1, shutter control section 4 has a configuration that controls the light transmission amounts of the shutters. However, shutter control section 4 may have a configuration that controls the durations of the open periods of the shutters, similarly to Embodiment 2.

Embodiment 3 has a configuration that controls the screen brightness of the left-eye video and the right-eye video, which the stereoscopic display apparatus displays, by controlling backlight control section 60. However, Embodiment 3 may be combined with Embodiment 1 to control both of the backlight control section and the liquid crystal drive section, thereby controlling screen brightness.

In each of Embodiments, a liquid crystal device having a liquid crystal panel and a backlight has been described as an example of the stereoscopic display apparatus; however, the present invention is not limited thereto. For example, an organic EL, display apparatus and a plasma display panel display apparatus may be used. In this case, the video brightness control section may have any configuration that controls the screen brightness of left and right images, which each display displays, according to the amounts of transmitting light in the left and right shutters.

Although the stereoscopic display system, the stereoscopic display apparatus, and the stereoscopic image observation glasses according to the present invention have been described on the basis of Embodiments, the present invention is not limited to Embodiments. Various modifications to the present embodiments and forms configured by combining constituent elements in different embodiments that can be conceived by those skilled in the art without departing from the teachings of the present invention are included in the scope of the present invention.

The embodiments disclosed above are mere examples in all respects, and thus should not be construed to limit the present invention. The scope of the present invention is defined by the claims, not by the description, and all possible modifications having equivalents to those in the claims and within the scope of the claims are intended to be included in the present invention.

The disclosure of Japanese Patent Application No. 2009-277276, filed on Dec. 7, 2009, including the specification, drawings and abstract, is incorporated herein by reference in its entirety.

### INDUSTRIAL APPLICABILITY

The present invention is suitable as a stereoscopic display system, a stereoscopic display apparatus, and stereoscopic image observation glasses, capable of reducing crosstalk and flicker.

### REFERENCE SIGNS LIST

1, 101 Stereoscopic video processing section
2 Liquid crystal drive section
31 Liquid crystal panel
32 Backlight
4 Shutter control section
40L, 104L Left-side glass position control circuit
40R, 104R Right-side glass position control circuit
41L, 141L Left-side glass pulse width control circuit
41R, 141R Right-side glass pulse width control circuit
42L Left-side glass light-transmittance control circuit
42R Right-side glass light-transmittance control circuit
5, 105 Stereoscopic image observation glasses
5L, 105L Left shutter
5R, 105R Right shutter
6, 60 Backlight control section
7, 70 Flicker detection section
10 Stereoscopic display apparatus
100, 200 Stereoscopic display system

1. A stereoscopic display system including a stereoscopic display apparatus that temporarily alternately displays left-eye video and right-eye video based on inputted left-eye video signals and right-eye video signals, and stereoscopic image observation glasses which have a left shutter for a left eye and a right shutter for a right eye for controlling amounts of light to transmit toward the left eye and the right eye and with which the left-eye video and the right-eye video are observed, comprising:
an ambient light detecting section that detects ambient light of the stereoscopic display system; and
a shutter control section that controls the amounts of transmitting light in the left shutter and the right shutter such that variation in amounts of ambient light that is incident on the left shutter and the right shutter are reduced.

2. The stereoscopic display system according to claim 1, wherein the shutter control section controls the amount of transmitting in the left and right shutters by controlling light transmittances of open periods of the left and right shutters.

3. The stereoscopic display system according to claim 1, wherein the shutter control section controls the amounts of transmitting light in the left and right shutters by controlling durations of open periods of the left and right shutters.

4. The stereoscopic display system according to claim 1, further comprising a video brightness control section that controls brightness of the left-eye video and the right-eye video, which the stereoscopic display apparatus displays, according to the amounts of transmitting light in the left and right shutters.

5. The stereoscopic display system according to claim 4, wherein:
the stereoscopic display apparatus includes a liquid crystal panel section that modulates incident light from a rear surface in accordance with the left-eye video signals and the right-eye video signals and displays the left-eye video and the right-eye video, and a backlight section that illuminates the liquid crystal panel section with the light from the rear surface, and the video brightness control section controls the brightness of the left-eye video and the right-eye video by controlling light emission brightness of the backlight section.

6. The stereoscopic display system according to claim 4, wherein:
the stereoscopic display apparatus includes a liquid crystal panel section that modulates incident light from a rear surface in accordance with the left-eye video signals and the right-eye video signals and displays the left-eye video and the right-eye video, and a backlight section that illuminates the liquid crystal panel section with light from the rear surface; and
the video brightness control section controls the brightness of the left-eye video and the right-eye video by controlling a transmittance of the liquid crystal panel section.

7. The stereoscopic display system according to claim 5, wherein:
the ambient light detecting section detects a brightness variation period of the ambient light of the stereoscopic display system and determines existence or nonexistence of flicker caused by interference between the brightness variation period and open and closed periods of the left and right shutters; and
in a case where no flicker is detected, the video brightness control section performs control such that light emission of the backlight section is always in an ON state.

8. A stereoscopic display apparatus used for a stereoscopic display system including a stereoscopic display apparatus that temporarily alternately displays, left-eye video and right-eye video based on inputted left-eye video signals and right-eye video signals, and stereoscopic image observation glasses which have a left shutter for a left eye and a right shutter for a right eye for controlling light transmission amounts toward a left eye and a right eye and with which the left-eye video and the right-eye video are observed, comprising:
an ambient light detecting section that detects ambient light of the stereoscopic display apparatus; and
a shutter control section that controls the amounts of transmitting light in the left shutter and the right shutter such that variation in amounts of ambient light that is incident on the left shutter and the right shutter, is reduced.

9. The stereoscopic display apparatus according to claim 8, wherein the shutter control section controls the amounts of transmitting light in the left and right shutters by controlling light transmittances of open periods of the left and right shutters.

10. The stereoscopic display apparatus according to claim 8, wherein the shutter control section controls the amounts of transmitting light in the left and right shutters by controlling durations of open periods of each of the left and right shutters.

11. The stereoscopic display apparatus according to claim 8, further comprising a video brightness control section that controls brightness of the left-eye video and the right-eye video displayed, according to the amounts of transmitting light in the left and right shutters.

12. The stereoscopic display apparatus according to claim 11, further comprising:
a liquid crystal panel section that modulates incident light from a rear surface in accordance with the left-eye video signals and the right-eye video signals and displays the left-eye video and the right-eye video; and
a backlight section that illuminates the liquid crystal panel section with the light from the rear surface, wherein the video brightness control section controls the brightness of the left-eye video and the right-eye video by controlling light emission brightness of the backlight section.

13. The stereoscopic display apparatus according to claim 11, further comprising:
a liquid crystal panel section that modulates incident light from a rear surface in accordance with the left-eye video signals and the right-eye video signals and displays the left-eye video and the right-eye video; and
a backlight section that illuminates the liquid crystal panel section with the light from the rear surface, wherein the video brightness control section controls the brightness of the left-eye video and the right-eye video by controlling a transmittance of the liquid crystal panel section.

14. The stereoscopic display apparatus according to claim 12, wherein:
the ambient light detecting section detects a brightness variation period of the ambient light of the stereoscopic display apparatus and determines existence or nonexistence of flicker caused by interference between the brightness variation period and open and closed periods of the left and right shutters; and
in a case where the flicker is not detected, the video brightness control section performs control such that light emission of the backlight section is always in an ON state.

15. Stereoscopic image observation glasses used for a stereoscopic display system including a stereoscopic display apparatus that temporarily alternately displays left-eye video and right-eye video based on inputted left-eye video signals and right-eye video signals, and stereoscopic image observation glasses which have a left shutter for a left eye and a right shutter for a right eye for controlling light transmission amounts toward a left eye and a right eye and with which the left-eye video and the right-eye video are observed, the stereoscopic image observation glasses comprising:
an ambient light detecting section that detects ambient light of the stereoscopic image observation glasses; and
a shutter control section that controls the amounts of transmitting light in the left shutter and the right shutter such that variation in amounts of ambient light that is incident on the left shutter and the right shutter, is reduced.

16. The stereoscopic image observation glasses according to claim 15, wherein the shutter control section controls the amounts of transmitting light in the left and right shutters by controlling light transmittances of open periods of the left and right shutters.

17. The stereoscopic image observation glasses according to claim 15, wherein the shutter control section controls the amounts of transmitting light in the left and right shutters by controlling durations of open periods of the left and right shutters.

18. The stereoscopic image observation glasses according to claim 15, further comprising a video brightness control section that controls brightness of the left-eye video and the right-eye video, which the stereoscopic display apparatus displays, according to the amounts of transmitting light in the left and right shutters.

19. The stereoscopic image observation glasses according to claim 18, wherein the video brightness control section controls the brightness of the left-eye video and the right-eye video by controlling light emission brightness of a backlight section, the backlight section being included in the stereoscopic display apparatus and illuminating a liquid crystal, panel section with light from a rear surface, and the liquid crystal panel section modulating the incident light from the rear surface in accordance with the left-eye video signals and the right-eye video signals and displaying the left-eye video and the right-eye video.

20. The stereoscopic image observation glasses according to claim 18, wherein the video brightness control section controls the brightness of the left-eye video and the right-eye video by controlling a transmittance of a liquid crystal panel section, the liquid crystal panel section being included in the stereoscopic display apparatus, modulating incident light from a rear surface in accordance with the left-eye video signals and the right-eye video signals, and displaying the left-eye video and the right-eye video.

21. The stereoscopic image observation glasses according to claim 19, wherein:
the ambient light detecting section detects a brightness variation period of the ambient light of the stereoscopic image observation glasses and determines existence or nonexistence of flicker caused by interference between the brightness variation period and open and closed periods of the shutters; and
in a case where the flicker is not detected, the video brightness control section controls light emission of the backlight section to be always in an ON state.
